(19) United States
(12) Patent Application Publication
(10) Pub. No.: US 2013/0003690 A1
(43) Pub. Date: Jan. 3, 2013

(54) APPARATUS AND METHOD FOR TRANSMITTING AND RECEIVING CONTROL INFORMATION IN A WIRELESS COMMUNICATION SYSTEM

(75) Inventors: Dong Cheol Kim, Anyang-si (KR); Jin Young Chun, Anyang-si (KR); Han Gyu Cho, Anyang-si (KR); Wook Bong Lee, Anyang-si (KR)

(73) Assignee: LG ELECTRONICS INC., Seoul (KR)

(21) Appl. No.: 13/634,475

(22) PCT Filed: Mar. 14, 2011
(86) PCT No.: PCT/KR2011/001776

§ 371 Date: Sep. 12, 2012

(30) Foreign Application Priority Data
Mar. 14, 2011 (KR) 10-2011-0022549

(51) Int. Cl. H04W 72/04

(52) U.S. Cl. 370/329

(57) ABSTRACT

Disclosed are an apparatus and method for transceiving control information. A base station device which transmits control information according to the present invention has a transmitting antenna which transmits second control information containing information on the resource size of the first control information for uplink power control, to user equipment. A processor determines the resource size of the first control information using the number of uplink subframes and downlink subframes available in one frame, the number of fast feedback channels (FFBCHs), and ceil function.

### TECHNICAL FIELD

The present invention relates to wireless communication, and more particularly, to an apparatus and method for transmitting and receiving control information.

### BACKGROUND ART

In an IEEE 802.16m system which is an example of a wireless communication system, an eNode B (eNB) contains essential system parameters and system configuration information in a superframe header (SFH) which is one of downlink control channels and transmits the same to a user equipment (UE). In particular, the SFH includes system information necessary for the UE to perform initial network entrance, network reentrance or handover. Examples of the SFH include a primary superframe header (P-SFH) and a secondary superframe header (S-SFH). First, the P-SFH will be described. An eNB transmits a P-SFH to a UE in every superframe. The eNB may also transmit an S-SFH to the UE in every superframe. The SFH is referred to as a broadcast channel (BCH) (including a primary-BCH (P-BCH) and a secondary-BCH (S-BCH)) and is used as the same meaning as the BCH.

An Advanced-MAP (A-MAP) which is another downlink control channel includes unicast service control information. The A-MAP is also referred to as unicast control information. The unicast service A-MAP is roughly divided into a user-specific A-MAP and a non-user-specific A-MAP. The user-specific A-MAP is divided into an assignment A-MAP, a HARQ feedback A-MAP and a power control A-MAP.

### DISCLOSURE

### Technical Problem

An object of the present invention is to provide a method of transmitting control information at an eNB.

Another object of the present invention is to provide a method of receiving control information at a UE.

Another object of the present invention is to provide an eNB apparatus for transmitting control information.

Another object of the present invention is to provide a UE apparatus for receiving control information.

The technical problems solved by the present invention are not limited to the above technical problems and other technical problems which are not described herein will become apparent to those skilled in the art from the following description.

### Technical Solution

The object of the present invention can be achieved by providing a method of transmitting control information at a base station in a wireless communication system, including transmitting second control information including information of a resource size of first control information for an uplink power control to a user equipment (UE), wherein the resource size of the first control information is determined using a number of uplink subframes and downlink subframes available in one frame, a number of fast feedback channels (FFBCHs) and a ceil function.

The first control information may be power control advanced-MAP (PC A-MAP), and the second control information is a secondary-superframe header sub-packet1 information element (S-SFH SP1 IE). The resource size of the first control information may be ceil (the number of FFBCHs×the number of uplink subframes/the number of downlink subframes). The frame may be a time division duplex (TDD) frame.

According to another aspect of the present invention, there is provided a method of receiving control information at a user equipment (UE) in a wireless communication system, including receiving second control information including information of a resource size of first control information for an uplink power control from a base station, wherein the resource size of the first control information is determined using a number of uplink subframes and downlink subframes available in one frame, a number of fast feedback channels (FFBCHs) and a ceil function.

The method may further include detecting a location of third control information transmitted through the same message as the first control information based on the resource size of the first control information. The first control information may be power control advanced-MAP (PC A-MAP) and the second control information may be a secondary-superframe header sub-packet1 information element (S-SFH SP1 IE). The third control information may be assigned to a frequency region (domain) adjacent to the first control information within the message. The first control information may be power control advanced-MAP (PC A-MAP), the third control information may be a non-user-specific A-MAP, and the message may be an A-MAP.

According to another aspect of the present invention, there is provided a base station apparatus for transmitting control information in a wireless communication system, including a transmit antenna configured to transmit second control information including information of a resource size of first control information for an uplink power control to a user equipment (UE), and a processor configured to determine the resource size of the first control information using a number of uplink subframes and downlink subframes available in one frame, a number of fast feedback channels (FFBCHs) and a ceil function.

According to another aspect of the present invention, there is provided a user equipment (UE) apparatus for receiving control information in a wireless communication system, including a receive antenna configured to receive second control information including information of a resource size of first control information for an uplink power control from a base station, wherein the resource size of the first control information is determined using a number of uplink subframes and downlink subframes available in one frame, a number of fast feedback channels (FFBCHs) and a ceil function.

The UE apparatus may further include a processor configured to detect a location of third control information transmitted through the same message as the first control information based on the resource size of the first control information.

### Advantageous Effects

According to the present invention, since a UE becomes aware of the size of a PC A-MAP, it is possible to efficiently detect a non-user-specific A-MAP and to improve communication performance.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram showing the configuration of an eNB 105 and a user equipment (UE) 110 in a wireless communication system 100.

FIG. 2 is a diagram showing an example of the structure of an A-MAP region in an IEEE 802.16m system.

FIG. 3 is a diagram showing an example of signal flow between a UE and an eNB.

FIG. 4 is a diagram showing an example of a process of acquiring a PC A-MAP and detecting a start point of a non-user-specific A-MAP at a UE.

FIG. 5 is a diagram showing an example of a process of acquiring a PC A-MAP and performing uplink power control at a UE.

### BEST MODE

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment through which the present invention can be carried out. Hereinafter, the detailed description includes detailed matters to provide full understanding of the present invention. However, it will be apparent to those skilled in the art that the present invention can be carried out without the detailed matters. For example, the following description will be made on the assumption of an IEEE 802.16 mobile communication system, but the present invention is applicable to other mobile communication systems excluding the unique matters of the IEEE 802.16 system.

In some instances, well-known structures and devices are omitted in order to avoid obscuring the concepts of the present invention and the important functions of the structures and devices are shown in block diagram form. The same reference numbers will be used throughout the drawings to refer to the same or like parts.

In the following description, it is assumed that a terminal includes a mobile or fixed user end device such as a user equipment (UE), a mobile station (MS) and an advanced mobile station (AMS), and a base station includes a node of a network end communicating with a terminal, such as a Node-B, an eNode B, a base station and an access point (AP).

In a mobile communication system, a UE may receive information from an eNB in downlink and transmit information in uplink. Information transmitted or received by the UE include data and a variety of control information and a physical channel varies according to the kind and usage of information transmitted or received by the UE.

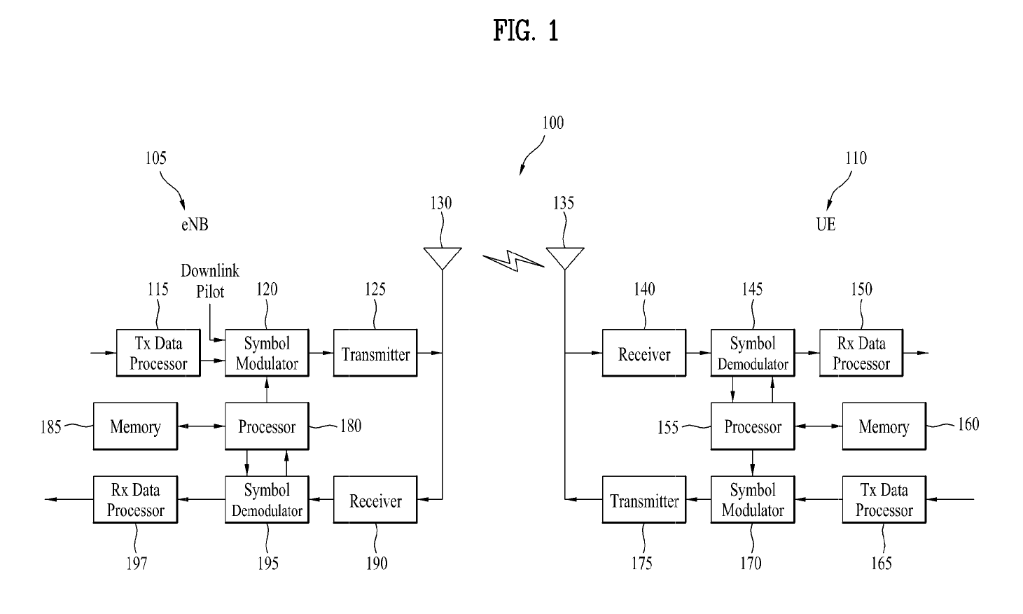

FIG. 1 is a block diagram showing the configuration of an eNB 105 and a UE 110 in a wireless communication system 100.

Although one eNB 105 and one UE 110 are shown in order to simplify the configuration of the wireless communication system 100, the wireless communication system 100 may include one or more eNBs and/or one or more UEs.

Referring to FIG. 1, the eNB 105 may include a transmission (Tx) data processor 115, a symbol modulator 120, a transmitter 125, a transmit/receive antenna 130, a processor 180, a memory 185, a receiver 190, a symbol demodulator 195, and a reception (Rx) data processor 197. The UE 110 may include a Tx data processor 165, a symbol modulator 170, a transmitter 175, a transmit/receive antenna 135, a processor 155, a memory 160, a receiver 140, a symbol demodulator 155, and an Rx data processor 150. Although one antenna 130 and one antenna 135 are respectively included in the eNB 105 and the UE 110, each of the eNB 105 and the UE 110 includes a plurality of antennas. Accordingly, the eNB 105 and the UE 110 according to the present invention support a Multiple Input Multiple Output (MIMO) system. The eNB 105 and the UE 110 according to the present invention support both a Single User-MIMO (SU-MIMO) scheme and a Multi User-MIMO (MU-MIMO) scheme.

In downlink, the Tx data processor 115 receives traffic data, formats and codes the received traffic data, interleaves and modulates the coded traffic data (or performs symbol mapping), and provides modulated symbols (“data symbols”). The symbol modulator 120 receives and processes the data symbols and pilot symbols and provides a symbol stream.

The symbol modulator 120 multiplexes data and pilot signals and transmits the multiplexed data to the transmitter 125. At this time, the transmitted symbols may be data symbols, pilot symbols or zero signal values. In each symbol period, the pilot symbols may be consecutively transmitted. The pilot symbols may be Frequency Division Multiplexed (FDM), Orthogonal Frequency Division Multiplexed (OFDM), Time Division Multiplexed (TDM) or Code Division Multiplexed (CDM) symbols.

The transmitter 125 receives and converts the symbol stream into one or more analog signals, additionally adjusts (e.g., amplifies, filters, and frequency-up-converts) the analog signals, and generates a downlink signal suitable for transmission through a radio channel. Subsequently, the downlink signal is transmitted to the UE through the antenna 130.

In the UE 110, the receive antenna 135 receives the downlink signal from the eNB and provides the received signal to the receiver 140. The receiver 140 adjusts (e.g., filters, amplifies, frequency-down-converts) the received signal and digitizes the adjusted signal so as to acquire samples. The symbol demodulator 145 demodulates the received pilot symbols and provides the demodulated pilot symbols to the processor 155, for channel estimation.

The symbol demodulator 145 receives downlink frequency response estimation values from the processor 155, performs data demodulation with respect to the received data symbols, acquires data symbol estimation values (which are estimation values of the transmitted data symbols), and provides the data symbol estimation values to the Rx data processor 150. The Rx data processor 150 demodulates (that is, symbol-demaps and deinterleaves) the data symbol estimation values, decodes the demodulated values, and restores transmitted traffic data.

The processes performed by the symbol demodulator 145 and the Rx data processor 150 are complementary to the processes performed by the symbol modulator 120 and the Tx data processor 115 of the eNB 105.

In the UE 110, in uplink, the Tx data processor 165 processes the traffic data and provides data symbols. The symbol modulator 170 receives the data symbols, multiplexes the data symbols, performs modulation with respect to the symbols and provides a symbol stream to the transmitter 175. The transmitter 175 receives and processes the symbol stream, generates an uplink signal, and transmits the uplink signal to the eNB 105 through the transmit antenna 135.

The eNB 105 receives the uplink signal from the UE 110 through the receive antenna 130 and the receiver 190 processes the received uplink signal and acquires samples. Subsequently, the symbol demodulator 195 processes the samples and provides pilot symbols received in the uplink and data symbol estimation values. The Rx data processor 197 processes the data symbol estimation values and restores traffic data transmitted from the UE 110.

The respective processors 155 and 180 of the UE 110 and the eNB 105 instruct (e.g., control, adjust, manages, etc.) the respective operations of the UE 110 and the eNB 105. The processors 155 and 180 may be connected to the memories 160 and 185 for storing program codes and data. The memories 160 and 185 may be respectively connected to the processors 155 and 180 so as to store operating systems, applications and general files.

Each of the processors 155 and 180 may also be referred to as a controller, a microcontroller, a microprocessor, a microcomputer, etc. The processors 155 and 180 may be implemented by hardware, firmware, software, or a combination thereof. If the embodiments of the present invention are implemented by hardware, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), etc. may be included in the processors 155 and 180.

If the embodiments of the present invention are implemented by firmware or software, the firmware or software may be configured to include modules, procedures, functions, etc. for performing the functions or operations of the present invention. The firmware or software configured to perform the present invention may be included in the processors 155 and 180 or may be stored in the memories 160 and 185 so as to be driven by the processors 155 and 180.

Layers of the radio interface protocol between the UE and the eNB in the wireless communication system (network) may be classified into a first layer (L1), a second layer (L2) and a third layer (L3) based on the three low-level layers of the well-known Open System Interconnection (OSI) model of a communication system. A physical layer belongs to the first layer and provides an information transport service through a physical channel. A Radio Resource Control (RRC) layer belongs to the third layer and provides control radio resources between the UE and the network. The UE and the eNB exchange RRC messages with each other through a wireless communication network and the RRC layer.

The above-described S-SFH is mapped to an S-SFH information element (IE). The S-SFH may be classified into three S-SFH subpacket IEs. The three S-SFH subpacket IEs are an S-SFH SP1 IE, an S-SFH SP2 IE and an S-SFH SP3 IE. Among others, the S-SFH SP1 IE includes a power control channel size indicator of 2 bits. The power control channel size indicator indicates the resource size of a power control A-MAP (hereinafter, referred to as a PC A-MAP).

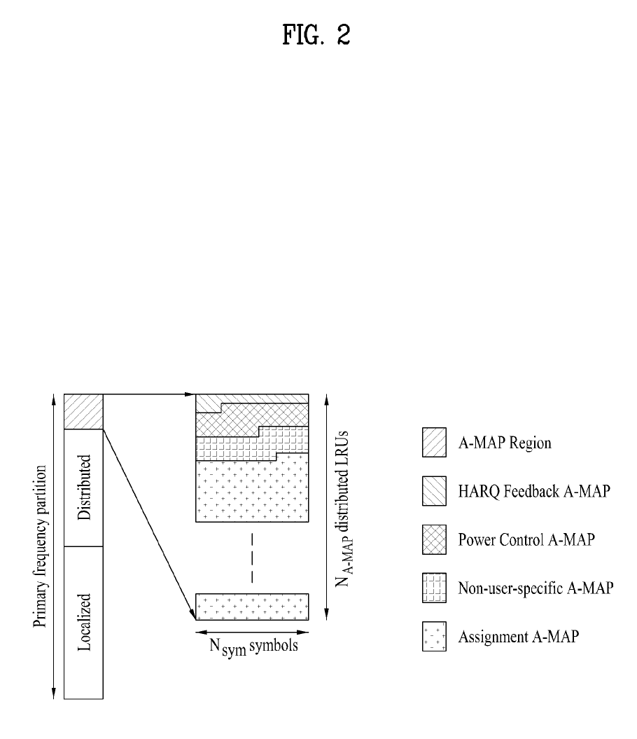

FIG. 2 is a diagram showing an example of the structure of an A-MAP region in an IEEE 802.16m system.

Referring to FIG. 2, as described above, an A-MAP which is control information is divided into a non-user-specific A-MAP and a user-specific A-MAP. The user-specific A-MAP includes an assignment A-MAP, a HARQ feedback A-MAP and a PC A-MAP. The A-MAP is located in a specific frequency and time domain as shown in FIG. 2. In the A-MAP region, the HARQ feedback A-MAP, the PC A-MAP, the non-user-specific A-MAP and the assignment A-MAP are assigned in this order. In order to easily decode the A-MAP, a UE needs to know the rule of resource assignment of the A-MAP. For example, if the UE is informed of the channel size and order of each A-MAP, the UE becomes implicitly aware of start and end locations. The UE may not decode an A-MAP which does not belong thereto and may attempt to decode another A-MAP.

The resource size of the HAQR feedback A-MAP may be fixed according to system bandwidth. The resource size of the PC A-MAP may be fixed according to bandwidth, FBCH or HARQ feedback channel (HFBCH). The resource size of the non-user-specific A-MAP may be fixed according to system bandwidth and the assignment A-MAP may be changed in the system bandwidth but the end location thereof may be checked through the non-user-specific A-MAP.

In the system, the HARQ feedback A-MAP starts from a logical index 0 according to a predefined rule and the size thereof is fixed. Therefore, the UE may confirm the end location of the HARQ feedback A-MAP and the end location of the HARQ feedback A-MAP becomes a start location of the PC A-MAP. The UE may confirm the resource size of the PC A-MAP (or the PC A-MAP IE) through a resource size indicator of a power control channel. In addition, the end point of the PC A-MAP becomes a start location of the non-user-specific A-MAP and the size of the non-user-specific A-MAP is fixed. Therefore, the UE may implicitly confirm the start location of a next assignment A-MAP. In addition, the UE may implicitly confirm the end point of the assignment A-MAP through an immediately preceding non-user-specific A-MAP.

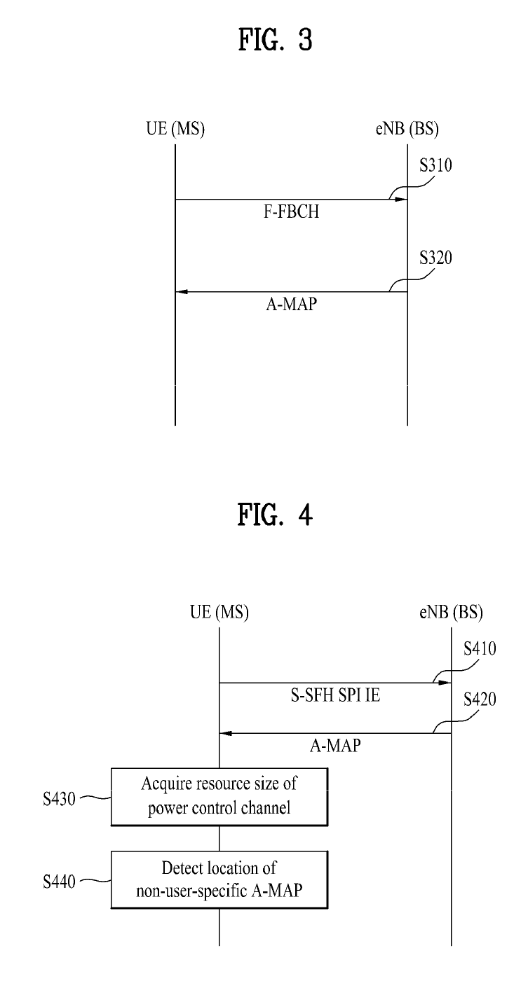

FIG. 3 is a diagram showing an example of signal flow between a UE and an eNB.

Referring to FIG. 3, the UE may transmit feedback information through a fast feedback channel (FFBCH), which is an uplink control channel, to the eNB (S310). The eNB should transmit a PC A-MAP (or a PC A-MAP IE) to the UE which transmits the FFBCH. Accordingly, the eNB determines a power correction value based on a received signal to interference plus noise ratio (SINR) of the UE which transmits the FFBCH, includes the power correction value in the PC A-MAP and transmits the power correction value to the UE through the A-MAP (S320). Since the PC A-MAP is synchronized with transmission of the FFBCH which is the uplink control channel, the UE may implicitly confirm the channel index of the received PC A-MAP based on the FFBCH index. The number of UEs which receive the PC A-MAP may be equal to or less than the number of UEs which transmit the FFBCH. The PC A-MAP may include PC A-MAP IEs using two or four tones/subcarriers.

The above-described three S-SFH subpackets (that is, the S-SFH SP1 IE, the S-SFH SP2 IE and the S-SFH SP3 IE) may be transmitted at different timings and with different periods. At this time, the periods of the S-SFH subpackets are decreased in order of the S-SFH SP3 IE, the S-SFH SP2 IE and the S-SFH SP1 IE. That is, a method of configuring a superframe header is determined depending on information importance and update periodicity. The UE may receive all information about a superframe header broadcast by the eNB and appropriately perform a communication operation with the eNB.

Conventionally, a resource size indicator of a PC A-MAP is not defined. However, the resource size indicator of the PC A-MAP needs to be defined such that the UE implicitly detects the location of non-user-specific A-MAP information. Hereinafter, a method of determining a resource size indicator of a power control channel in an S-SFH SP1 IE will be proposed.

Table 1 shows an example of information about a resource size indicator of a PC A-MAP.

TABLE 1

| Syntax | Size (bit) | Notes |
|---|---|---|
| Power control channel | 2 | Total number of PC |
| resource size indicator | | A-MAP IE, N_{PC A-MAP-IE} |
| | | 0b00: 0 (No use of PC A-MAP IE) |
| | | 0b01: 14 if UFPC is |
| | | 00b10: 28 if UFPC is |
| | | 00b11: 44 if UFPC is 0 |

The size of the PC A-MAP is influenced by the number of distributed logical resource units (DLRUs) and a HARQ feedback channel size. Accordingly, determining the size of the PC A-MAP by taking some of various cases into account may cause system resource waste.

A feedback channel (FBCH) includes a HARQ feedback channel and a fast feedback channel (FFBCH). The size of the FBCH (hereinafter, referred to as UL_FEEDBACK_SIZE) is defined as distributed LRUs in a specific frequency partition FPi and the number L_{FB,Fpi} of the feedback channels of FPi may be defined by Equation 1.

L_{FB,FPi}=N_{fb}×UL_FEEDBACK_SIZE Equation 1

where, N_{fb} is generally 3 and may be defined as 4 in a subframe supporting uplink partially used subcarrier (PUSC) permutation and supporting a legacy system using a frequency division multiplexing (FDM) scheme. Here, the legacy system is a system of a previous version of a current wireless communication system. For example, the legacy system of the IEEE 802.16m system is the IEEE 802.16e system. One frequency partition (FP) index may be specified and used. For example, since a control channel need not be restricted by transmit power, it may be assumed that the control channel is transmitted only in a designed FP. The eNB may inform the UE of UL_FEEDBACK_SIZE using 4 bits in the S-SFH SP3 IE.

The number L_{FB,FPi} of feedback channels is influenced by the frequency partition rule and information about whether a legacy mode is supported or not. The number of FFBCHs may be obtained using Equation 2.

L_{FFB,FPi}=L_{FB,FPi}−k×L_{HFB}/6 Equation 2

where, L_{FFB,FPi} denotes the number of fast feedback channels of a frequency partition i (FPi), and L_{HFB} denotes a value of which the eNB informs the UE according to system bandwidth in the S-SFH SP1 IE using the following method. L_{HFB} denotes the number of uplink HARQ channels per HARQ region defined in the S-SFH SP1, has a size of 2 bits, and indicates any one of 6, 12, 18 and 24 in a bandwidth of 5 MHz, any one of 6, 12, 24 and 30 in a bandwidth of 10 MHz and any one of 12, 24, 48 and 60 in a bandwidth of 20 MHz. k is determined according to a ratio of the number of downlink subframes to the number of uplink subframes within a frame and indicates a minimum value in a HARQ region in an uplink subframe. For example, if the ratio of the number of downlink subframes to the number of uplink subframes is 6:2, 5:3 or 4:4, k may be 3, 2 or 1. In addition, if the ratio of the number of downlink subframes to the number of uplink subframes is 3:5 or 2:6, k may be 0.

L_{FFB,FPi} is influenced by the system bandwidth and the method of configuring L_{HFB} within the system bandwidth. The number L_{FFB,FPi} of fast feedback channels of the frequency partition i (FPi) may be determined according to system bandwidth (5/10/20 MHz), the configuration method of L_{HFB} in a system bandwidth type, the frequency partition rule, whether a legacy mode is supported, k, etc.

The eNB should calculate many parameters and inform the UE of the many parameters because the number of channels of the PC A-MAP is defined by the number L_{FFB,FPi} of fast feedback channels of the frequency partition i (FPi). However, if a maximum value is always preset with respect to the system bandwidth, resource waste occurs.

Accordingly, the UE may obtain the total number of FFBCHs using L_{HFB} of Equation 2 which is received from the eNB through the S-SFH SP1 IE and UL_FEEDBACK_SIZE of Equation 1 which is received through the S-SFH SP3 IE. The total number of FFBCHs may be the resource size of the PC A-MAP. That is, the resource size of the power control channel=L_{FFB,FPi} may be defined.

Accordingly, the eNB does not need to separately broadcast the number of FFBCHs to the UE. In addition, since the number of FFBCHs is determined by taking various cases into account, it is possible to prevent resource waste due to presetting of a maximum value and reduce control overhead. Alternatively, the number L_{FFB,FPi} of FFBCHs may be changed according to the k factor in uplink subframe units. Then, the size of the PC A-MAP may be changed in downlink subframe units.

The number L_{FFB,FPi} of FFBCHs may be changed according to the ratio of the number of downlink subframes to the number of uplink subframes and the resource size of the PC A-MAP is also changed. As an example, the resource size of the PC A-MAP may be expressed by Equation 3.

Resource size of the PC A-MAP IE=Ceil (the number of uplink subframes×the number of FFBCHs/the number of downlink subframes) Equation 3

where, the number of downlink/uplink subframes denotes the number of downlink/uplink subframes in one frame, and a ceil (k) function denotes a function for rounding off to the nearest whole number. For example, Ceil(2.1)=3 and Ceil(4)=4.

If a downlink subframe in which the PC A-MAP may be transmitted is defined, the resource size of the PC A-MAP may be obtained. If the ratio of the number of downlink subframes to the number of uplink subframes is 3:5, only two of three downlink subframes may be used. For example, if a system bandwidth is 20 MHz, DLRU=15, H-FBCH=12, k=1, N_{fb}=3 and the ratio of the number of downlink subframes to the number of uplink subframes is 3:5, the processor 155 of the UE calculates the size of the PC A-MAP which will be transmitted in one downlink subframe as follows. First, L_{FB,FPi}=3×15=45 if Equation 1 is used, and L_{FB,FPi}=45−1×12/6=43 if Equation 2 is used. If Equation 3 is used, the resource size of the PC A-MAP=Ceil(5×43/3)=72. Accordingly, the resource size of the PC A-MAP which will be transmitted by the eNB in one subframe is 72. A series of calculation processes may be performed by the processor 155 of the UE. If N_{fb}=4, the resource size of the PC A-MAP becomes 97.

As another example, if a system bandwidth is 5 MHz, DLRU=15, H-FBCH=6, k=1, N_{fb}(Mzone)=3 and the ratio of the number of downlink subframes to the number of uplink subframes is 3:5, when the processor 155 of the UE calculates the size of the PC A-MAP which will be transmitted in one downlink subframe using the above-described calculation method, the size of the PC A-MAP becomes 74. In addition, if N_{fb}=4, the size of the PC A-MAP becomes 79.

As another example, if a system bandwidth is 8.75 MHz, DLRU=15, H-FBCH=6, k=1, N_{fb}=3 and the ratio of the number of downlink subframes to the number of uplink subframes is 2:4, when the processor 155 of the UE calculates the size of the PC A-MAP which will be transmitted in one downlink subframe using the above-described calculation method, the size of the PC A-MAP becomes 88. In addition, if N_{fb}=4, the size of the PC A-MAP becomes 118.

Although the processor 155 of the UE calculates the size of the PC A-MAP in the above description, the eNB may calculate the size of the PC A-MAP and inform the UE of the size of the PC A-MAP. The eNB may implicitly or explicitly inform the UE of the size of the PC A-MAP per subframe in which the PC A-MAP is transmitted. Alternatively, the eNB may inform the UE of a maximum PC A-MAP size value among downlink subframes.

The resource size of the PC A-MAP is calculated after the UE receives the S-SFH SP1 IE and the S-SFH SP3 IE from the eNB. Therefore, if any one of the S-SFH SP1 IE and the S-SFH SP3 IE is not received, the resource size of the PC A-MAP cannot be calculated. Accordingly, UL_FEEDBACK_SIZE information (e.g., 4 bits) may be transferred from the S-SFH SP3 IE to the S-SFH SP1 IE.

Unlike the above description, the resource size of the PC A-MAP may be calculated by the number of uplink subframes×the number of FFBCHs and the eNB may inform the UE of the resource size of the PC A-MAP. In this case, one downlink subframe PC A-MAP may indicate the power correction values of all UEs which transmit the FFBCH in a previous frame. In this case, the power correction value may be transmitted only in a predetermined downlink subframe. At this time, an available downlink subframe is set to 1.

Tables 2 and 3 show other examples of information about the resource size indicator of the PC A-MAP included in the S-SFH SP1 IE.

TABLE 2

| | Size | |
|---|---|---|
| Syntax | (bit) | Notes |
| Power control | 2 | Total number of PC A-MAP IE, N_{PC A-MAP-IE} |
| channel | | 0b00: 0 (No use of PC A-MAP IE) |
| resource size | | 0b01: Ceil(14 × U/D) |
| indicator | | 0b10: ceil(28 × U/D) |
| | | 0b11: ceil(47 or 48 × U/D) |
| | | where, U and D denote the number of subframes |
| | | available in one frame in uplink and |
| | | downlink, respectively. |

TABLE 3

| | Size | |
|---|---|---|
| Syntax | (bit) | Notes |
| Power control | 2 | Total number of PC A-MAP IE, N_{PC A-MAP-IE} is |
| channel | | the total number of PC A-MAP IEs of the |
| resource size | | PC A-MAP region |
| indicator | | 0b00: 0 (No use of PC A-MAP IE) |
| | | 0b01: 2 × Ceil(7 × U/D) |
| | | 0b10: 2 × ceil(14 × U/D) |
| | | 0b11: 2 × ceil(24 × U/D) |
| | | where, U and D denote the number of subframes |
| | | available in one frame in uplink and |
| | | downlink, respectively. |

Referring to Tables 2 and 3, the processor 180 of the eNB may calculate the resource size of the PC A-MAP IE and inform the UE of the resource size of the PC A-MAP IE through a resource size indicator field of a power control channel of an S-SFH SP1 IE. At this time, the processor 180 of the eNB may determine the resource size of the PC A-MAP IE using the number of uplink/downlink subframes available in one frame (or the ratio of the number of downlink subframes to the number of uplink subframes), the number of FFBCHs and the ceil function. In particular, when the eNB transmits the PC A-MAP symbols, since the number of chains of the PC A-MAP IE mapped to the PC A-MAP symbols is an even number, the resource size of the PC A-MAP IE needs to always be an even number as shown in Table 3.

FIG. 4 is a diagram showing an example of a process of acquiring a PC A-MAP and detecting a start point of a non-user-specific A-MAP at a UE.

Referring to FIG. 4, the UE may receive an S-SFH SP1 IE from an eNB in a predetermined period (S410). The UE may receive an A-MAP from the eNB in every downlink subframe (S420). The order of steps S410 and S420 may be changed. The processor 155 of the UE may decode a resource size indicator field of a power control channel included in the S-SFH SP1 IE received from the eNB (S430). If the resource size indicator field of the power control channel is decoded, the processor 155 of the UE may become aware of the resource size of the PC A-MAP IE (or the PC A-MAP) (S430). Since a variety of A-MAP information included in the A-MAP is mapped to resources in a predetermined order, the processor 155 of the UE confirms the resource size of the PC A-MAP IE and detects the location (that is, the start point) of a non-user-specific A-MAP because the non-user-specific A-MAP is assigned adjacent to the PC A-MAP (S440). Thereafter, the UE may receive control information broadcast in a state of being included in the non-user-specific A-MAP.

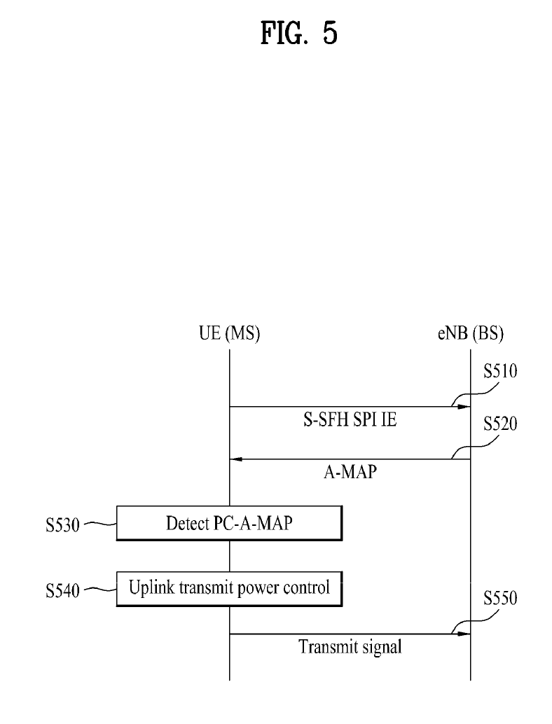

FIG. 5 is a diagram showing an example of a process of acquiring a PC A-MAP and performing uplink power control at a UE.

Referring to FIG. 5, the UE may receive an S-SFH SP1 IE from an eNB in a predetermined period (S510). The processor 155 of the UE may decode a resource size indicator field of a power control channel included in the S-SFH SP1 IE received from the eNB so as to confirm the resource size of the power control channel. The UE may receive an A-MAP from the eNB in every downlink subframe (S520). The UE may detect a PC A-MAP IE in the A-MAP through the resource size information of the power control channel confirmed through the resource size indicator field of the power control channel (S530). Here, step S510 may be omitted. That is, the UE need not necessarily receive the S-SFH SP1 IE including the resource size indicator field of the power control channel in order to detect the PC A-MAP. The PC A-MAP IE may include information shown in Table 4.

TABLE 4

| Syntax | Size (bit) | Notes |
|---|---|---|
| PC-A-MAP IE | | |
| format { | | |
| Power correction | 2 | 0b00 = −0.5 dB |
| value | | 0b01 = 0.0 dB |
| | | 0b10 = 0.5 dB |
| | | 0b11 = 1.0 dB |
| } | | |

The PC A-MAP IE includes a power correction value having a size of 2 bits. Such a power correction value may be used for uplink power control (in particular, uplink control channel power control) of the processor 155 of the UE. Hereinafter, Equation 4 used for uplink power control by the UE in the IEEE 802.16m system which is an example of a mobile communication system will be described. In general, the UE needs to determine an uplink transmit power value when transmitting an uplink signal. The power correction value having a size of 2 bits, which is included in the PC A-MAP IE, may correspond to an offset (in particular, an offset for a control channel) of Equation 4.

P(dBm)=L+SINR_{Target}+NI+Offset

where, P denotes a transmit power level (dBm unit) per subcarrier and stream in current transmission and L denotes current average downlink propagation loss estimated by the UE. L includes transmit antenna gain of the UE and path loss. SINR_{Target} is a target uplink SINR value transmitted from the eNB to the UE. NI denotes an average noise and interference level (dBm unit) per subcarrier, which is estimated by the eNB and is transmitted from the UE to the eNB. The offset is a correction term for a power offset per UE. This offset value is transmitted by the eNB through a power control message. There are two kinds of offsets: offsetdata which is an offset value used to transmit data and offsetcontrol which is an offset value used to transmit control information.

The UE may immediately apply Equation 4 using Table 1 which predefines a target SINR value corresponding to a control channel for transmitting control information.

TABLE 5

| Control Channel Type | SINR_{Target} Parameters |
|---|---|
| HARQ Feedback | targetHarqSinr |
| Synchronized Ranging | targetSyncRangingSinr |
| P-FBCH | targetPfbchSinr |
| S-FBCH | targetSfbchBaseSinr |
| | targetSfbchDeltaSinr |
| Bandwidth Request | targetBwRequestSinr |

However, when the UE transmits data, it is necessary to set the target SINR value using Equation 5.

$${SINR}_{Target} = 10 log 10 ( max ( 10 \hat{} ( \frac{{SINR}_{MIN} ( dB )}{10} ) , {γ}_{toT} \times {SIR}_{DL} - α ) ) - β \times 10 log 10 ( TNS ) \qquad Equation 5$$

where, SINR_{MIN}(dB) denotes a minimum SINR value required by the eNB and is set by a unicast power control message. SINR_{MIN} is expressed by 4 bits and the value thereof may be, for example, one of {−∞, −3, −2.5, −1, 0, 0.5, 1, 1.5, 2, 2.5, 3, 3.5, 4, 4.5}. SIR_{DL} means a ratio of a downlink signal measured by the UE to interference power.

γ_{IoT} is a fairness and IoT control factor and is broadcast from the eNB to the UE. Alpha (α) is a factor according to the number of receive antennas of the eNB and is signaled as 3-bit MAC power control mode signaling and the value thereof may be, for example, expressed by a value of {1, ½, ¼, ⅛, 1/16, 0}. Beta (β) may be set to 0 or 1 by 1-bit MAC power control mode signaling.

TNS is the total number of streams in a logical resource unit (LRU) indicated by a UL-A-MAP IE and is set to Mt in case of single user-MIMO (SU-MIMO). Mt is the number of streams per user and is set to TNS, which is the total number of streams, in case of CSM. In case of control channel transmission, Mt may be set to 1.

The processor 155 of the UE may determine uplink transmit power using the power correction value included in the detected PC A-MAP IE and L, NI and SINR_{Target} values (S540). Thereafter, the UE may transmit the determined uplink transmit power value to the eNB as an uplink signal (S550).

Hereinafter, the S-SFH SP1 IE format, etc., when the IEEE 802.16m system supports a legacy mode, will be described. If the legacy mode is supported, the number of feedback channels (FBCHs) may be expressed by Equation 6.

L_{FB,FPi}=N_{fb}×UL_FEEDBACK_SIZE Equation 6

where, N_{fb} is 4 and UL_FEEDBACK_SIZE is from 1 LRU to 16 LRUs.

Table 6 shows the number of FBCHs and the number of H-FBCHs in case of 5/10/20 MHz when the legacy mode is supported.

TABLE 6

| | Number of LRUs | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| Number of | 4 | 8 | 12 | 16 | 20 | 24 | 28 | 32 | 36 | 40 | 44 | 48 | 52 | 56 | 60 | 64 |
| FBCHs | | | | | | | | | | | | | | | | |

Number of FFBCHs
H-FBCH at 5 MHz

| | | | | | | | | | | | | | | | | |
|---|---|---|---|---|---|---|---|---|---|---|---|---|---|---|---|---|
| Ob00 | 3 | 7 | 11 | 15 | 19 | 23 | 27 | 31 | 35 | 39 | 43 | 47 | 51 | 55 | 59 | 63 |
| Ob01 | | 6 | 10 | 14 | 18 | 22 | 26 | 30 | 34 | 38 | 42 | 46 | 50 | 54 | 58 | 62 |
| 0b10 | | 5 | 9 | 13 | 17 | 21 | 25 | 29 | 33 | 37 | 41 | 45 | 49 | 53 | 57 | 61 |
| 0b11 | | | 8 | 12 | 16 | 20 | 24 | 28 | 32 | 36 | 40 | 44 | 48 | 52 | 56 | 60 |

H-FBCH at 10 MHz

| | | | | | | | | | | | | | | | | |
|---|---|---|---|---|---|---|---|---|---|---|---|---|---|---|---|---|
| Ob00 | 3 | 7 | 11 | 15 | 19 | 23 | 27 | 31 | 35 | 39 | 43 | 47 | 51 | 55 | 59 | 63 |
| Ob01 | | 6 | 10 | 14 | 18 | 22 | 26 | 30 | 34 | 38 | 42 | 46 | 50 | 54 | 58 | 62 |
| 0b10 | | | 8 | 12 | 16 | 20 | 24 | 28 | 32 | 36 | 40 | 44 | 48 | 52 | 56 | 60 |
| 0b11 | | | | 11 | 15 | 19 | 23 | 27 | 31 | 35 | 39 | 43 | 47 | 51 | 55 | 59 |

H-FBCH at 20 MHz

| | | | | | | | | | | | | | | | |
|---|---|---|---|---|---|---|---|---|---|---|---|---|---|---|---|
| Ob00 | 6 | 10 | 14 | 18 | 22 | 26 | 30 | 34 | 38 | 42 | 46 | 50 | 54 | 58 | 62 |
| Ob01 | | 8 | 12 | 16 | 20 | 24 | 28 | 32 | 36 | 40 | 44 | 48 | 52 | 56 | 60 |
| 0b10 | | | | | 16 | 20 | 24 | 28 | 32 | 36 | 40 | 44 | 48 | 52 | 56 |
| 0b11 | | | | | | 18 | 22 | 26 | 30 | 34 | 38 | 42 | 46 | 50 | 54 |

If the legacy mode is supported at each system bandwidth in the uplink FDM format, about 50% of resources cannot be used. If a maximum number of LRUs is 8, a maximum number of FFBCHs is 31, but should be always a multiple of 2 because an information configuration of the PC A-MAP uses an SFBC transmission method (tone pair permutation in downlink). Accordingly, the maximum number of FFBCHs needs to be set to 32, which may be expressed by 2*ceil(16*D/U). However, if there is no restriction that the maximum number of FFBCHs is always a multiple of 2, the legacy supporting mode (FDM type) may be defined as in Tables 7, 8, 9 and 10.

TABLE 7

| | Size | |
|---|---|---|
| Syntax | (bit) | Notes |
| Power control | 2 | Total number of PC A-MAP IE, N_{PC A-MAP-IE} is |
| channel | | the total number of PC A-MAP IEs of the |
| resource size | | PC A-MAP region |
| indicator | | 0b00: 0 (No use of PC A-MAP IE) |
| | | 0b01: 2 × Ceil(10 × D/U) |
| | | 0b10: 2 × ceil(19 × D/U) |
| | | 0b11: 2 × ceil(32 × D/U) |
| | | where, U and D denote the number of subframes |
| | | available in one frame in uplink and downlink, |
| | | respectively. |

TABLE 8

| | Size | |
|---|---|---|
| Syntax | (bit) | Notes |
| Power control | 2 | Total number of PC A-MAP IE, N_{PC A-MAP-IE} is |
| channel | | the total number of PC A-MAP IEs of the |
| resource size | | PC A-MAP region |
| indicator | | 0b00: 0 (No use of PC A-MAP IE) |
| | | 0b01: Ceil(19 × D/U) |
| | | 0b10: ceil(38 × D/U) |
| | | 0b11: ceil(63 × D/U) |
| | | where, U and D denote the number of subframes |
| | | available in one frame in uplink and downlink, |
| | | respectively. |

TABLE 9

| | Size | |
|---|---|---|
| Syntax | (bit) | Notes |
| Power control | 2 | Total number of PC A-MAP IE, N_{PC A-MAP-IE} is |
| channel | | the total number of PC A-MAP IEs of the |
| resource size | | PC A-MAP region |
| indicator | | 0b00: 0 (No use of PC A-MAP IE) |
| | | 0b01: Ceil(14 × U/D) |
| | | 0b10: ceil(28 × U/D) |
| | | 0b11: ceil(44 × U/D) |
| | | If the legacy supporting mode is of an FDM |
| | | type in uplink, the total number of PC A-MAP |
| | | IE, N_{PC A-MAP-IE} is |
| | | 0b00: 0 (No use of PC A-MAP IE) |
| | | 0b01: Ceil(19 × U/D) |
| | | 0b10: ceil(38 × U/D) |
| | | 0b11: ceil(63 × U/D) |
| | | where, U and D denote the number of subframes |
| | | available in one frame in uplink and downlink, |
| | | respectively. |

TABLE 10

| | Size | |
|---|---|---|
| Syntax | (bit) | Notes |
| Power control | 2 | Total number of PC A-MAP IE, N_{PC A-MAP-IE} |
| channel | | 0b00: 0 (No use of PC A-MAP IE) |
| resource size | | 0b01: ceil(14 × U/D) |
| indicator | | 0b10: ceil(28 × U/D) |
| | | 0b11: ceil(44 × U/D) |
| | | If the legacy supporting mode is of an FDM |
| | | type in uplink, the total number of PC A-MAP |
| | | IE, N_{PC A-MAP-IE} is |
| | | 0b00: 0 (No use of PC A-MAP IE) |
| | | 0b01: 2 × ceil(10 × U/D) |
| | | 0b10: 2 × ceil(19 × U/D) |
| | | 0b11: 2 × ceil(32 × U/D) |
| | | where, U and D denote the number of subframes |
| | | available in one frame in uplink and downlink, |
| | | respectively. |

The size of the PC A-MAP has 2 bits, 0b00 indicates 0 when the PC-A-MAP is not used, and 0b01, 0b10 and 0b11 may be set by dividing the number of LRUs of the FBCH by an appropriate ratio. Accordingly, the integer values of the ceil functions of Tables 7 to 10 may be defined by the following concept. For example, in a system using 16 LRUs, an upper limit value of the integer value may be set to 5, 10 or 16. A method of dividing the LRUs may be differently set and thus the number of FFBCHs of Table 6 may be taken into account. If the integer value is expressed in the form of 2×ceil( ) the finally calculated value is an even number which is greater than or equal to the number of FFBCHs necessary for each LRU.

The eNB may not inform the UE of the resource size of the PC A-MAP but the resource size of the PC A-MAP may be confirmed based on basic information known to the eNB and the UE. In a wireless communication system, a determination as to whether or not a PC A-MAP is used upon uplink power control may be made. In a wireless communication system, if uplink power control (ULPC) is performed without using the PC A-MAP, the UE unnecessarily decodes the PC A-MAP when reading the A-MAP. Accordingly, an indicator indicating whether the PC A-MAP is used or not is set for normal operation of the eNB and the UE. The indicator may be signaled from the eNB to the UE using 1 bit (that is, 0: disable, 1: able) or a predetermined PC A-MAP indicator may be used. For example, the eNB may inform the UE of the indicator using a superframe header, a message indicating system information or a message for assigning uplink resources.

If the PC A-MAP is mainly used to set uplink power necessary to transmit a control channel, the eNB may inform the UE of the indicator only through a message for assigning a control channel. Alternatively, the eNB may inform the UE of the indicator using a newly defined message type.

As described above, various methods of obtaining the resource size of the PC A-MAP (the resource size of the power control channel) were described. In the present invention, regardless of the method of obtaining the resource size, if the eNB informs the UE of the PC A-MAP indicator (abbreviated to PI) (0 or 1) or if the UE becomes aware of the indicator value using a predetermined method, the resource size of the PC A-MAP may be confirmed using PI×power control channel resource size.

The case where the PC A-MAP is always used or is not always used may be taken into account using the PC A-AMP indicator. The PC A-MAP indicator may be set periodically, aperiodically, or using an event triggering method. In addition, a method of setting and using a timer in a predetermined time interval is possible. An indicator indicating whether the PC A-MAP is used or not may be set such that the PC A-MAP need not necessarily be used through a power control channel upon uplink power control operation. This aids in acquisition of other A-MAP information in a state of confirming the size of the PC A-MAP.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with other claims referring to the other claims other than the specific claims to constitute the embodiment or add new claims by means of amendment after the application is filed.

Those skilled in the art will appreciate that the present invention may be carried out in other specific ways than those set forth herein without departing from the spirit and essential characteristics of the present invention. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

The apparatus and method for transmitting and receiving control information is industrially applicable to various communication systems such as 3GPP LTE, LTE-A and IEEE 802.

1. A method of transmitting control information at a base station in a wireless communication system, the method comprising:
transmitting second control information including information of a resource size of first control information for an uplink power control to a user equipment (UE),
wherein the resource size of the first control information is determined using a number of uplink subframes and downlink subframes available in one frame, a number of fast feedback channels (FFBCHs) and a ceil function.

2. The method according to claim 1, wherein the first control information is power control advanced-MAP (PC A-MAP).

3. The method according to claim 1, wherein the second control information is a secondary-superframe header sub-packet1 information element (S-SFH SP1 IE).

4. The method according to claim 1, wherein the resource size of the first control information is ceil (the number of FFBCHs×the number of uplink subframes/the number of downlink subframes).

5. The method according to claim 1, wherein the frame is a time division duplex (TDD) frame.

6. A method of receiving control information at a user equipment (UE) in a wireless communication system, the method comprising:
receiving second control information including information of a resource size of first control information for uplink power control from a base station,
wherein the resource size of the first control information is determined using a number of uplink subframes and downlink subframes available in one frame, a number of fast feedback channels (FFBCHs) and a ceil function.

7. The method according to claim 6, further comprising:
detecting a location of third control information transmitted through the same message as the first control information based on the resource size of the first control information.

8. The method according to claim 6, wherein the first control information is power control advanced-MAP (PC A-MAP) and the second control information is a secondary-superframe header sub-packet1 information element (S-SFH SP1 IE).

9. The method according to claim 7, wherein the third control information is assigned to a frequency region adjacent to the first control information within the message.

10. The method according to claim 7, wherein the first control information is power control advanced-MAP (PC A-MAP), the third control information is a non-user-specific A-MAP, and the message is an A-MAP.

11. A base station apparatus for transmitting control information in a wireless communication system, the base station apparatus comprising:
a transmit antenna configured to transmit second control information including information of a resource size of first control information for an uplink power control to a user equipment (UE), and
a processor configured to determine the resource size of the first control information using a number of uplink subframes and downlink subframes available in one frame, a number of fast feedback channels (FFBCHs) and a ceil function.

12. The base station apparatus according to claim 11, wherein the first control information is power control advanced-MAP (PC A-MAP).

13. The base station apparatus according to claim 11, wherein the second control information is a secondary-superframe header sub-packet1 information element (S-SFH SP1 IE).

14. The base station apparatus according to claim 11, wherein the resource size of the first control information is ceil (the number of FFBCHs×the number of uplink subframes/the number of downlink subframes).

15. A user equipment (UE) apparatus for receiving control information in a wireless communication system, the UE apparatus comprising:
a receive antenna configured to receive second control information including information of a resource size of first control information for an uplink power control from a base station,
wherein the resource size of the first control information is determined using a number of uplink subframes and downlink subframes available in one frame, a number of fast feedback channels (FFBCHs) and a ceil function.

16. The UE apparatus according to claim 15, further comprising:
a processor configured to detect a location of third control information transmitted through the same message as the first control information based on the resource size of the first control information.

17. The UE apparatus according to claim 15, wherein the first control information is power control advanced-MAP (PC A-MAP) and the second control information is a secondary-superframe header sub-packet1 information element (S-SFH SP1 IE).

18. The UE apparatus according to claim 16, wherein the third control information is assigned to a frequency region adjacent to the first control information within the message.

19. The UE apparatus according to claim 16, wherein the first control information is power control advanced-MAP (PC A-MAP), the third control information is a non-user-specific A-MAP, and the message is an A-MAP.
